(19) United States
(12) Patent Application Publication
(10) Pub. No.: US 2005/0271837 A1
(43) Pub. Date: Dec. 8, 2005

(54) Joint material between a spacer and a glass substrate

(76) Inventor: Albane Benardais, Massy (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/531,440

(22) PCT Filed: Nov. 19, 2003
(86) PCT No.: PCT/FR03/03424

§ 371 Date: Apr. 14, 2005

(30) Foreign Application Priority Data
Dec. 4, 2002 (FR) 0215256

(51) Int. Cl. E06B 3/24

(52) U.S. Cl. 428/34

(57) ABSTRACT

A joint material for joining at least one ceramic-based or glass-based spacer to a glass substrate, including an enamel mixed with at least one metal oxide in the form of particles.

The invention relates to a joint material for joining at least one ceramic-based or glass-based spacer to a glass substrate.

Spacers bonded to a glass substrate are used in the production, for example, of flat emissive screens such as FED (field emission displays) screens composed of two substrates between which a space of small thickness is maintained by means of said spacers.

An FED screen comprises a cathode and an anode that are formed by two flat glass substrates facing each other. Electron-emitting elements, such as for example metal microchips or carbon nanotubes, are deposited on the cathode, while light-emitting phosphor materials corresponding to the colors, green, red and blue, are in particular deposited on the anode. Electrons are extracted from the cathode by means of an extraction voltage applied between the cathode and electrodes called “gate electrodes” placed on the same substrate. These electrons emitted by the cathode are then accelerated by the electric field generated by applying a voltage between the anode and the cathode. They reach the phosphors on the anode, which, when excited, emit their color and generate an image. A well-defined space, typically from 0.1 to 5 mm, separates the two mutually sealed substrates, a vacuum being maintained in this space, called the “gap”. Because of the vacuum between the two substrates, the difference in pressure with the outside creates a force that tends to crush the substrates. Thus, to withstand the atmospheric pressure so that the screen does not implode, spacing elements—the spacers—are placed between the two substrates, which keep the two glass substrates a certain distance apart.

The use of spacers bonded to at least one glass substrate is not, of course, limited to this FED screen application, and other uses for which it is also necessary to maintain a constant separation between two substrates, may be envisioned, such as for example plasma screens, flat lamps, vacuum double-glazing units, or thermochromic windows. The expression “flat lamps” must be understood as encompassing lamps that may have a curvature on at least a part of their surface, whatever the technology of these lamps.

In general, these spacers are used to form spacing elements or separators between two substrates.

Spacers may be bonded to a glass substrate in various ways.

One proposed solution is that described in patent U.S. Pat. No. 6,042,445. In that document, one end of the spacer is coated with a metallic material by known deposition techniques, of the vacuum deposition type, and the substrate is also covered with a metallic coating by known techniques, again of the vacuum deposition type. The metallic materials used are preferably made from gold, but may also be chosen from aluminum, copper or nickel. The metal-covered spacers are applied against the metallized substrate and a heat source, such as a laser, is directed at the assembly so as to bond the two metallized elements.

U.S. Pat. No. 5,561,343 proposes another solution, namely ultrasonic bonding. That document shows that one end of the spacers is provided with a metal comprising gold or aluminum, capable of undergoing ultrasonic bonding, and the substrate includes metallized regions against which the ends of spacers are intended to be applied. Bonding is achieved using ultrasound, delivered by a suitable device.

However, these metallization operations, being sometimes difficult to implement and/or being expensive, and possibly requiring steps in addition to a simple bonding operation, go counter to the ever desirable aim of improving production costs.

Moreover, when used for emissive screens, especially FED screens for which charge exchange takes place between cathode and anode so as to activate the phosphors, the spacers may pick up surface charges that run the risk of having an undesirable influence on phosphors which are adjacent to those that have been activated and which, in contrast, it is desired not to activate.

Moreover, in this type of emissive screen application, it is necessary to provide bonding means and possibly a bonding method which ensure that the spacers are positioned perfectly, so that they provide lasting mechanical strength, without the screen imploding.

Furthermore, the positioning of the spacers at the desired points in the plane of the substrate and in a direction perfectly perpendicular to the plane of the substrate, in a repeated manner for all of the spacers over the entire substrate, is also important when manufacturing a screen for which the phosphors are placed after, and depending on, the positioning of said spacers.

It is therefore an object of the invention to propose bonding means that do not cause the aforementioned drawbacks and can ensure suitable positioning of the spacers while fulfilling the function of draining away the charges that appear on the surface of the spacers, so as to prevent the creation of spurious charges that would inopportunely activate the phosphors.

The invention achieves this by means of a joint material that is characterized in that it comprises an enamel mixed with at least one metal oxide in the form of particles. Advantageously, the metal oxide is stable over time and with temperature up to 600° C. at most. It contains one or more of the following elements: Zr, V, Al, Cr, Mn, Fe, Ca, Si, Co, Ni, Zn, Ti, Ni, Nb, W, Sb, Pb, Sn, Cu, Ru, Ir. Preferably, it is ruthenium oxide.

According to one feature, the material has a resistivity of between 10⁵ and 10¹⁰ Ω.cm.

According to another feature, the material includes at least one solvent and some resin. Advantageously, the material has a viscosity at room temperature of at most 50 Pa·s.

The material of the invention makes it possible to produce a structure comprising two glass substrates kept apart using spacers being bonded by one of their ends to at least one substrate by virtue of said joint material.

According to one feature of such a structure, the opposite end of the spacers that rests against the other substrate is coated with at least one bonding material which may include the joint material. Advantageously, the joint material may constitute a means suitable for making up for a height difference between one end of a spacer and a substrate.

In such a structure, the spacers may or may not be electrically conducting.

Advantageously, the contact resistance of the joint material located between a spacer and a substrate is negligible compared with the resistance of the spacer.

The method of bonding spacers to a glass substrate by means of the material of the invention is characterized in that the spacers are kept in a fixed position and are covered on one of their ends with the joint material, and the glass substrate is placed against said ends of the spacers covered with the joint material, the entire structure—substrate and spacers—then undergoing an annealing operation. Temperature of at most 600° C. is defined as the annealing temperature.

Advantageously, the opposite end of the spacers that are joined to the substrate as explained above is covered with a bonding material and another substrate is placed against said ends of the spacers, the assembly comprising two substrates and the spacers then undergoing a final annealing operation.

In a variant of the method, the spacers coated with the joint material on one or both of their ends are annealed prior to their being joined to the substrate.

Finally, the material of the invention can be used in the manufacture of emissive screens, of the plasma screen or FED screen type, flat lamps, insulating vacuum windows and thermochromic windows.

Other features and advantages of the invention will become apparent on reading the description that follows, together with the appended drawings in which:

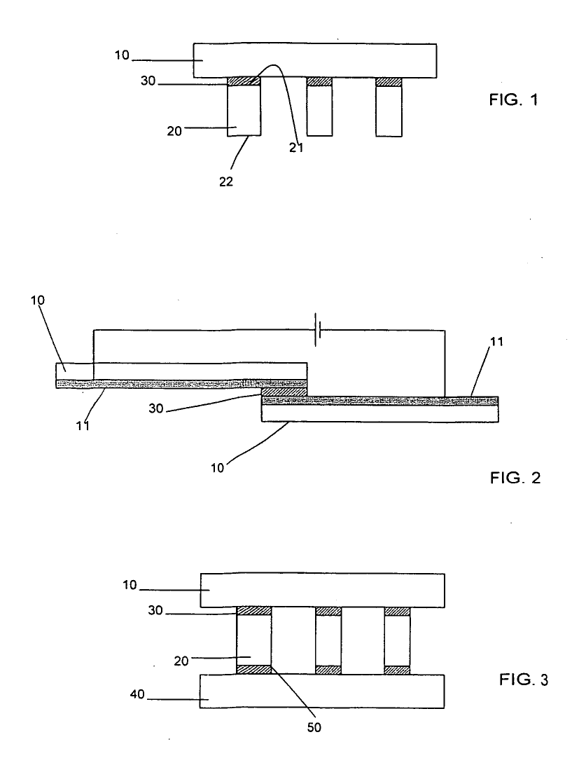

FIG. 1 illustrates the joint material for joining spacers to a substrate;

FIG. 2 illustrates the device for measuring the resistivity of the joint material; and

FIG. 3 shows the structure of FIG. 1 when joined to another substrate.

The figures have not been drawn to scale in order to make them easier to understand.

FIG. 1 illustrates a substrate 10 to which spacers 20 are bonded by means of a joint material 30.

The substrate 10 is made of glass and has a plane surface on a side on which the spacers are bonded.

The spacers 20 are glass-based or ceramic-based, they may or may not be electrically conducting and they may be of various shapes, the cross section of which may in particular be circular, rectangular or cruciform.

They are bonded to the substrate 10 via one of their ends 21.

The joint material 30, when it is put in place and provides its bonding function, uniformly covers the end 21 of the spacers. It has a thickness of around 1 to 100 μm in an FED screen application.

The joint material 30 comprises an enamel mixed with at least one electrically conducting element, in particular a metal oxide in the form of particles.

The enamel is based on a glass whose composition is chosen from the sealing frit compositions normally used in the glass industry. The sealing operation involves heating to a temperature of at most 600° C. For application in an emissive screen, the sealing temperature is preferably between 400 and 550° C. In other applications, for example for bonding spacers as separating elements for vacuum-type insulating glazing, the sealing may be carried out at lower temperatures of around 200° C., which thus make it possible to avoid soaking the glazing and/or to reduce the cost of sealing them.

The metal oxide particles make the joint material electrically conducting so that the material can fulfil, in addition to its bonding function, the function of draining away electrical charges that may be contained at the surface of the spacers.

The material must be sufficiently conducting to remove said electrical charges. Its electrical resistivity must, however, remain high enough to prevent parasitic emission. Parasitic emission occurs, for example, in a field emission screen when only a voltage between the cathode and the anode is applied without providing an extraction voltage. Under these conditions, the cathode does not emit electrons. However, because of the electric field created by the voltage applied between the cathode and the anode, electrons are extracted from the conducting joint material and inopportunely excite the phosphors, constituting parasitic emissions observed all around the spacer.

So as to be able simultaneously to drain away the electrical charges on the spacers and limit the risk of parasitic emission, the material has a resistivity p of between 10⁵ Ω.cm and 10¹⁰ Ω.cm. This value is given for a material that has already undergone various heat treatments corresponding to the treatments that the material undergoes during manufacture of an FED-type emission screen.

The resistivity is measured at room temperature on a specimen of the material 30 with an area A, for example 1 cm², and a thickness t, for example 15 μm. The specimen is bonded to two substrates 10 coated with a conducting layer 11 (FIG. 2) in order to constitute two electrodes between which a voltage is applied, the combinations—substrates and specimens—having undergone the heat treatments necessary for manufacturing an emissive screen. By varying the voltage, for example between 0 and 200 V, the current is measured and from this is deduced a resistance value which, from the thickness t and the area A of the specimen, allows its resistivity ρ to be deduced.

The metal oxide present in the form of particles in the joint material, after having undergone an annealing operation, must have the following properties:
it must be stable over time and with temperature, that is to say the oxide does not dissolve in the enamel, and in particular within a temperature range for which the joint material can withstand several annealing operations and up to 600° C., especially under vacuum, or in air or in an inert gas, for the purpose of withstanding the process for sealing the spacers on the substrate and the manufacturing process, for example for manufacturing emissive screens, using a substrate of this type provided with spacers;
it must not generate visible parasitic emission around the spacers. This is why it is preferred to use a metal oxide rather than a metal for providing the electrical conductivity property of the joint material. This is because the inventors have demonstrated that, owing to the fact that a metal has a lower electron work function than metal oxides, electrons will be less easily extracted in an electric field in the case of metal oxides, which will further limit the risk of parasitic emission; and
it must be able to be uniformly distributed in the enamel of the material, so that the charges can be drained away over the entire distribution of joint material and any accumulation of electrical charge at certain points in the joint material, which would otherwise create a high perturbation in the electric field existing in the gap separating the anode from the cathode, is prevented. This disturbed field would deflect the electrons emitted by the cathode from their ideal path, which could then inopportunely excite the phosphors.

The metal oxide particles contain one or more of the following elements, which do not dissolve in the enamel at the temperatures described above, in particular up to 600° C.: Zr, V, Al, Cr, Mn, Fe, Ca, Si, Co, Ni, Zn, Ti, Ni, Nb, W, Sb, Pb, Sn, Cu, Ru, Ir. Ruthenium oxide will be preferred, because it also has a suitable resistivity.

The joint material therefore also has properties suitable for the process for depositing it on the end 21 of the spacers. Thus, the material must have a viscosity at room temperature of less than 50 Pa·s. A pine oil, such as terpineol, may be used as solvent for controlling the viscosity. The proportion of solvent used will determine the viscosity.

The material chosen will also be one that exhibits tack upon being applied to the spacers before any treatment associated with a bonding process, such as annealing or ultraviolet cross linking. This tack may be obtained by means of the resin, such as ethyl cellulose, contained in the joint material. This resin disappears after the first annealing operation.

The method of bonding spacers to a substrate using the joint material of the invention, for example for the purpose of manufacturing a structure with substrates separated by spacers, such as an FED screen, will now be described.

In a first step, the sealing of a first substrate with the spacers is carried out in an open environment, and in a second step the sealing is carried out in a closed environment, that is to say said substrate provided with the spacers is hermetically sealed with another element, such as another substrate (FIG. 3).

During the first step, the joint material is deposited by any suitable means on the ends 21 of the spacers, the ends being held in a periodic array in one and the same plane; the substrate is then placed against the spacers and a vacuum annealing operation at about 550° C. is carried out on the assembly in order to consolidate the bonding, the removal of the solvents and of the resin, which may possibly be polluting, being carried out by any suitable means. The removal of the solvents and the resin is useful at this stage in an open environment since otherwise, if the structure in the case of an FED screen, were to be sealed in a single step and therefore in a closed environment, the solvents and the resin that have been volatilized by the heating of the joint material could concentrate, over the course of time, in the hermetic sealed medium between the two substrates, which could contaminate the elements of the screen, such as the phosphors and the electron-emitting elements, degrading the performance of the screen.

It should be noted that the joint material may be deposited on the spacers by, for example, depositing a layer of the material on a plate of size at least approximately equal to the area over which the spacers are distributed. Whilst the spacers are being held in position by a device, for example having a large number of grippers, the plate coated with the material is temporarily applied, if necessary with slight pressure, against the ends of the spacers in order to deposit said material. As a variant, the spacers held in position are introduced, at their ends, into a bath of adhesive in order to deposit it.

The material of the invention, by way of its tack before even a first annealing operation, makes it possible, when joining the substrate to the spacers that have been provided with the material, to keep the spacers in place without any risk of them being unintentionally displaced. This is because any positioning error could cause, when the substrate with spacers is being used, problems of inadvertent operation, such as the undesirable activation of certain phosphors in an emission screen.

In addition, because of its suitable viscosity, the adhesive is distributed uniformly on the ends of the spacers, which makes it possible to obtain balanced and uniform electrical conduction at the end of the spacers via which the electrical charges are intended to be drained away as regards application in an emissive screen. This is because, should there be any electrical conduction irregularity, the field lines generated by the accumulation of charges at a point would result in the deflection of the electrons emitted by the cathode, and thus these would turn on the phosphors that it is desired not to activate.

In the second step, another substrate 40 is placed against the other free end 22 of the spacers that have possibly been precoated with a bonding material 50, such as the joint material of the invention for example, a sealing means (glass frit or material of the invention) being, moreover placed in the manner of a frame round the entire periphery of one of the substrates. By carrying out one or more annealing operations on the assembly, depending on its application, and by exerting pressure on the second substrate, the assembly is sealed.

Advantageously, in the case of an FED screen and as regards the first and/or second steps, an annealing operation will be carried out just after deposition of the joint material against the ends of the spacers, and before said spacers are joined to the substrate or substrates, so as to remove the solvents and the resin. Lastly, the screen is sealed by at least one annealing operation at a temperature below 500° C. for example, and at the same time a vacuum is created inside the screen. In this way, the joint material softens and, owing to the effect of the atmospheric pressure that is exerted against the external faces of the screen, the joint material at the ends 21 and/or 22 of the spacers is compressed against the substrate(s), thus ensuring a better conducting bond.

For optimal charge draining, the inventors have demonstrated that it is necessary for the contact resistance of the joint material located between a spacer and a substrate to be negligible compared with the resistance of the spacer. The term “negligible” is understood to mean smaller by at least a factor of 10.

To ensure that this feature is achieved, the inventors have demonstrated that it is sufficient to measure the resistance of the entire structure, composed of the spacers, the joint material and the substrates coated with conductive coating, in order to constitute electrodes and to compare it to the expected or calculated total resistance of the spacers, knowing the number of them, their geometry and the resistivity of the material or materials of which they are composed. The resistance of the structure is deduced by applying a variable voltage between the two substrates of the structure and measuring the current. When the measured resistance of the structure is approximately equivalent to the expected resistance of the spacers, the contact resistance is actually regarded as being negligible.

An additional advantage is provided by the use of the joint material as means of bonding the spacers to the substrate, by allowing the use of spacers substantially smaller in size than that required, and corresponding for example to the separation of the two substrates. This is because it happens that few spacers are manufactured with a height less than the desired size—nevertheless they could all be used as separating elements since the material will make up for the difference in height when joining the spacers to the two substrates.

It should be noted that the use of spacers bonded with the joint material of the invention may be envisioned in any application requiring two substrates to be kept constantly apart. By way of non-limiting example, applications may be in field emission screens, plasma screens, flat lamps, vacuum double glazing or thermochromic windows.

1-17. (canceled)

18. A joint material for joining at least one ceramic-based or glass-based spacer to a glass substrate, comprising:
an enamel mixed with at least one metal oxide in a form of particles.

19. The material as claimed in claim 18, having a resistivity of between 10⁵ and 10¹⁰ Ω·cm.

20. The material as claimed in claim 18, wherein the metal oxide particles are stable over time and with temperature up to 600° C. at most.

21. The material as claimed in claim 18, wherein the metal oxide particles contain one or more of the following elements: Zr, V, Al, Cr, Mn, Fe, Ca, Si, Co, Ni, Zn, Ti, Ni, Nb, W, Sb, Pb, Sn, Cu, Ru, Ir.

22. The material as claimed in claim 18, wherein the metal oxide is ruthenium oxide.

23. The material as claimed in claim 18, having a viscosity of at most 50 Pa;s.

24. The material as claimed in claim 18, further comprising at least one solvent and some resin.

25. A structure comprising:
first and second glass substrates kept apart using spacers, the spacers being bonded by first of their ends to at least the first substrate, by virtue of the joint material as claimed in claim 18.

26. The structure as claimed in claim 25, wherein second ends of the spacers that rest against the second substrate are coated with at least one bonding material.

27. The structure as claimed in claim 26, wherein the bonding material includes the joint material.

28. The structure as claimed in claim 25, wherein the joint material includes means for making up for a height difference between one end of a spacer and a substrate.

29. The structure as claimed in claim 25, wherein the spacers are electrically conducting.

30. The structure as claimed in claim 25, wherein the spacers are not electrically conducting.

31. The structure as claimed in claim 25, wherein a contact resistance of the joint material located between a respective spacer and a substrate is negligible compared with resistance of the spacer.

32. A method of bonding spacers to a glass substrate by a joint material as claimed in claim 18, wherein the spacers are kept in a fixed position and are covered on first of their ends with the joint material, and the glass substrate is placed against the ends of the spacers covered with the joint material, an entire structure of the substrate and spacers then undergoing an annealing operation.

33. The method as claimed in claim 32, wherein second ends of the spacers that are joined to the substrate are covered with a bonding material and another substrate is placed against the ends of the spacers, the assembly comprising two substrates and the spacers then undergoing an annealing operation.

34. The method as claimed in claim 32, wherein the spacers coated with the joint material on one or both of their ends are annealed prior to the spacers being joined to the substrate.

35. The use of the joint material as claimed in claim 18 in a manufacture of emissive screens, of a plasma screen or FED screen type, flat lamps, insulating vacuum glazing, and thermochromic windows.
